(19) United States
(12) Patent Application Publication
(10) Pub. No.: US 2023/0340841 A1
(43) Pub. Date: Oct. 26, 2023

(54) Designing For Permeability Of Filter Cake To Control Lost Circulation

(71) Applicant: Halliburton Energy Services, Inc., Houston, TX (US)

(72) Inventors: John Paul Bir Singh, Houston, TX (US); Siva Rama Krishna Jandhyala, Houston, TX (US); Krishna Babu Yerubandi, Houston, TX (US); Ronnie Glen Morgan, Duncan, OK (US); Aleksey Kolasnikov, Houston, TX (US)

(73) Assignee: Halliburton Energy Services, Inc., Houston, TX (US)

(21) Appl. No.: 17/727,001

(22) Filed: Apr. 22, 2022

(51) Int. Cl. E21B 21/00; C09K 8/50; E21B 47/10

(52) U.S. Cl. CPC E21B 21/003; C09K 8/50; E21B 47/10

(57) ABSTRACT

Methods of the present disclosure relate to designing lost circulation material (LCM) based on permeability of filter cake. A method comprises determining if a lost circulation material (LCM) has the potential to bridge a fracture, the fracture extending from a wellbore; determining a permeability of filter cake formed due to the LCM, wherein the permeability is determined if the LCM has the potential to bridge the fracture; and formulating a composition that includes the LCM, to control losses from the wellbore.

### BACKGROUND

During cementing and drilling, the choice of lost circulation material (LCM) and its loading is done using experiential based heuristics. In many cases, even when the base fluid design is changed, the LCM and loading may not be updated because the design engineer does not have the appropriate experience and/or analytical tools to account for the interaction between the base fluid design, rheology of the fluid, loss mechanism, observed losses during operations, fluid volumes being pumped and choice of LCM (which may be one material or combination of multiple LCMs) and its loading. Therefore, here in after, LCM will refer to either a single LCM material or product, or combinations of multiple LCM products.

Typically to cure losses, an appropriately sized and shaped LCM needs to be added to the fluids. The choice of LCM is made just based on its size (and shape) compared to estimated fracture width. However, curing losses successfully is a complex function of various fluid and fracture characteristics and choosing the LCM based on only size and shape may be insufficient.

### BRIEF DESCRIPTION OF THE DRAWINGS

These drawings illustrate certain aspects of some of the examples of the present disclosure and should not be used to limit or define the disclosure.

FIG. 1 illustrates a flow chart for designing a filter cake with low permeability to control losses, in accordance with examples of the present disclosure;

FIGS. 2A and 2B illustrate controlling circulation loss as a two-step process, in accordance with examples of the present disclosure;

FIG. 2C illustrates a close-up view of the filter cake, in accordance with examples of the present disclosure;

FIG. 3 illustrates an operative sequence for a fracture bridging simulator, in accordance with examples of the present disclosure;

FIG. 4 illustrates triple cascade operative sequences for a fracture bridging simulator, in accordance with examples of the present disclosure;

FIGS. 5A-5C illustrate cumulative bridging of different sized LCM particles disposed in a fracture or pore, in accordance with examples of the present disclosure;

FIG. 6 illustrates a system for the preparation of a designed composition including the LCM, and subsequent delivery of the fluid to an application site, in accordance with examples of the present disclosure;

FIG. 7 illustrates a system that may be used in the placement of the designed composition, in accordance with examples of the present disclosure;

FIG. 8 illustrates the designed composition placed into a subterranean formation, in accordance with particular examples of the present disclosure;

FIG. 9 illustrates that the permeability of filter cake increases significantly with LCM particle size, in accordance with examples of the present disclosure;

FIG. 10 illustrates that the permeability of the filter cake is severely limited with the presence of finer particles, in accordance with examples of the present disclosure;

FIG. 11 illustrates a model for fines in the filter cake, in accordance with examples of the present disclosure;

FIG. 12 illustrates an LCM package, in accordance with examples of the present disclosure;

FIG. 13 illustrates another LCM package, in accordance with examples of the present disclosure;

FIGS. 14A-14D illustrate LCM bridges with different LCM weights in a fracture, in accordance with examples of the present disclosure;

FIG. 15 illustrates cumulative distribution of the LCM packages according to size, in accordance with examples of the present disclosure; and

FIG. 16 illustrates a model for filtration of LCM material, in accordance with examples of the present disclosure.

### DETAILED DESCRIPTION

Methods of the present disclosure relate to designing a composition that includes LCM, based on the permeability of the resulting filter cake, to control losses from a wellbore. The permeability of the filter cake depends not just on the LCM used (large particles), but also on the different sized particles in the base fluid (e.g., medium and small). The permeability of the filter cake directly depends on the particle size. In other words, the larger the particle size, the higher the permeability through the LCM bridge. As LCM generally includes large particles (relative to the size of the fracture opening), the permeability of the resulting filter cake is generally high and is not sufficient to control the lost circulation.

Thus, a presence of medium and small sized particles provides control over the losses. The methods as disclosed herein determine the amount of fines (e.g., medium and small particles) which are filtered by the LCM bridge, and hence, determine the permeability of the filter cake which includes the medium and small particles trapped in the LCM bridge. When coupled with the wellbore hydraulics software, the methods also account for the rheology and density of the fluid(s) in the wellbore as well as the state of the wellbore which includes time dependent positions of the various fluids in the wellbore, current loss rate, fluid currently at the loss zone, and its rheology in the fracture.

The methods take into account the following: lost circulation mechanism and the fracture characteristics (fracture width, height, orientation, and permeability of the formation); fluid rheology and density; propensity for the LCM particles with a given PSD and shape to bridge a fracture of given characteristics; and propensity of the LCM material to filter finer particles to result in a filter cake via a wellbore fluid hydraulics simulator. The methods may be used to determine the actual volume of fluid required for successful cementing operation, i.e., reach the desired top of cement (TOC). The methods allow an engineer to compare available choices of fluids and LCM and choose optimal materials and fluids for the job based on filter cake permeability.

The methods enable an illustration of the additive components of fluid consumption within a wellbore during a cementing job, such as: spacer volume required to transport and deposit LCMs; spacer volume required to ensure effective mud solids and filter cake removal inside casing or liner walls; spacer volume required to ensure annular hole cleaning; spacer volume required to ensure effective fluid displacement; efficient design of service; spacer volume required to ensure annular hole cleaning; spacer volume required to ensure effective fluid displacement; efficient design of service; and the effectiveness of the LCM portfolio and the solutions available for various loss circulation situations.

In particular examples, the fracture is characterized using known loss rates under given wellbore conditions. Once that is established, the fluid design including an LCM and known medium and small sized particles at given concentration is proposed. Using the known fracture size, rheology of the fluid, amount, particle size distribution (PSD), and shape of the LCM, the method determines if the LCM is able to bridge the LCM.

Additionally, a determination is made as to the fraction of fines that are filtered by the filter cake. The amount of the LCM and other finer particles (small and medium sized particles) is used to determine the size and permeability of cake at any given time. Using this methodology, a design engineer may be able to create various scenarios of fluid solutions and evaluate their ability to form a competent (less permeable) cake.

In some examples, the fracture is characterized using known loss rates under given wellbore conditions. Once that is established, the fluid design including an LCM at a given concentration is proposed. Using the known fracture size, rheology of the fluid, amount, PSD and shape of the LCM, the method determines if the LCM is able to bridge the LCM. In addition, a determination is made as to the fraction of LCM which might be retained in the filter cake being formed. Using this information as well as the porosity of the filter cake, the permeability of the filter cake is determined. Which, in turn, is used to determine the updated loss rate of the fluid. Using this methodology, a determination as to the effectiveness of LCM package to provide loss control may be determined. Depending on the needs, the LCM package in the fluid may be modified to provide appropriate control on loss circulation. LCM package may include a mixture of more than one loss circulation material mixed together. The mixture may be made to have desired PSD, might have differently shaped particles or different materials for their other properties such as hardness, elasticity, etc.

Thus, a design engineer may be able to create various scenarios of fluid solutions and evaluate them and design the service appropriately. The methods enable the engineer to determine the amount of the clean spacer or fluid that will be lost into the fractures and pore throats while the LCM particles (and fines) are being stacked in order to minimize or eliminate the losses after sufficient delivery into the fractures. Thus, the appropriate LCM and loading may be determined, based on inventory and cost.

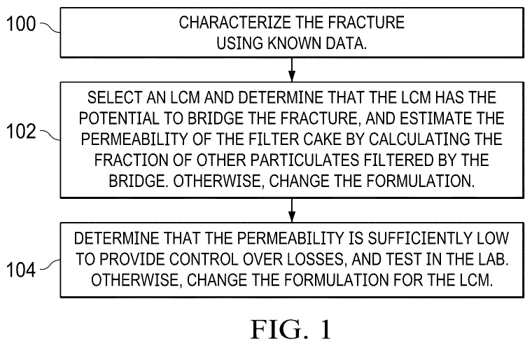

FIG. 1 illustrates a flow chart for designing a filter cake with low permeability to control losses, in accordance with examples of the present disclosure. At stage 100, a fracture in a wellbore may be characterized using known data such as for example, wellbore geometry, wellbore fluid properties (e.g., density, rheology), and loss rate as a function of wellbore depth and time.

At stage 102, an LCM may be selected. Multiple types of LCM may be selected for the following workflow. The LCM that has the potential (e.g., a probability) to bridge the fracture is determined via a fracture bridging simulator (e.g., software), and the permeability of the filter cake is estimated by calculating the fraction of other particulates filtered by the LCM bridge formed in the fracture. Each probability may be used as an acceptable threshold for selection. For example, a threshold of at least 25%, at least 50%, or at least 75% may be used to select the LCM. In some examples, multiple LCMs may be compared and the LCM(s) with the highest probability to bridge the fracture may be selected. The permeability may depend on LCM shape and PSD, fracture opening size and shape, base fluid properties (e.g., rheology), concentration of LCM, concentration of other particles in fluid and their PSD. If the LCM does not have the potential to bridge the fracture, the formulation for the LCM (e.g., type of LCM) may be changed until the LCM is sufficient to bridge the fracture. The fracture bridging simulator is described with reference in FIGS. 3-5C, below.

At stage 104, the permeability is determined to be sufficiently low to provide control over losses, and the LCM is tested in the lab. If the LCM filter cake does not have sufficiently low permeability, the formulation of the LCM may be changed. Permeability is comparable to the non-fractured formation, then it may be termed ‘sufficiently low.’ The other way is to have a model of fluid flow through the LCM filter cake. If the resulting predicted losses under wellbore conditions are small enough for the operations to proceed, then the permeability of the LCM filter cake may be deemed to be sufficiently low.

Factors affecting the permeability are: fluid composition (concentration of medium and small sized particles); fluid properties (rheology); type of LCM and concentration used. 250+ micron is large, 10-250 microns is medium and less than 10 microns is small.

LCM filter cake permeability for essentially monodisperse particles may be determined via Equation 1:

$$κ = {φ}^{2} \frac{{ε}^{3} {D}^{2}}{150 {( 1 - ε )}^{2}} \qquad ( 1 )$$

for a mixture of particles with different sizes, Dᵢ and volume fraction vᵢ, the net permeability is given by Equation 2.

$$\frac{1}{κ} = \frac{{V}_{1}}{{κ}_{1}} + \frac{{V}_{2}}{{κ}_{2}} + … \qquad ( 2 )$$

where φ is sphericity; E is porosity; D is particle diameter; vi is volume fraction of the particles with size Di. Equation 1 is for single mode PSD. Equation 2 is for multimodal PSD. For a mixture, smaller sized particles can sit in the interstices of larger particles.

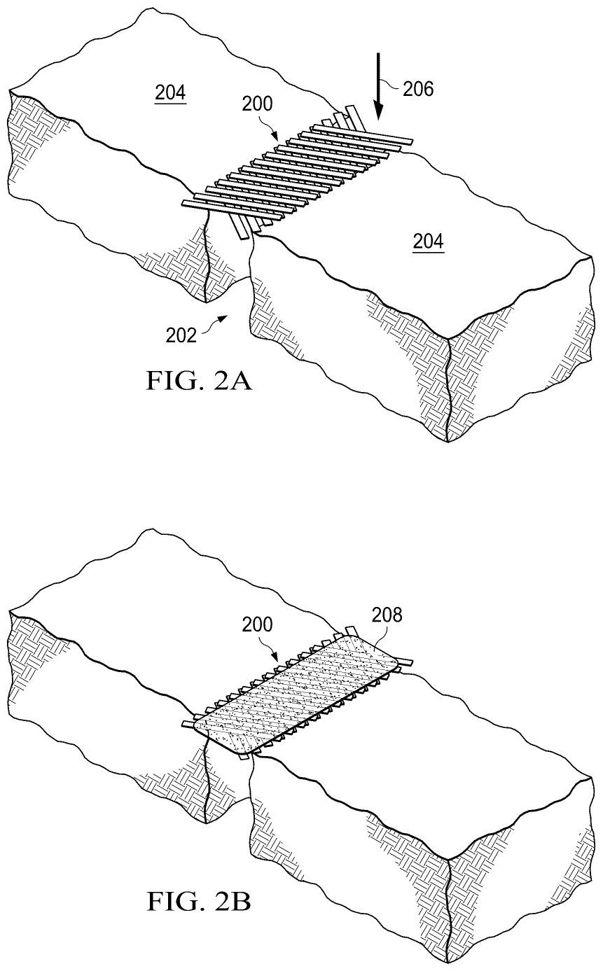

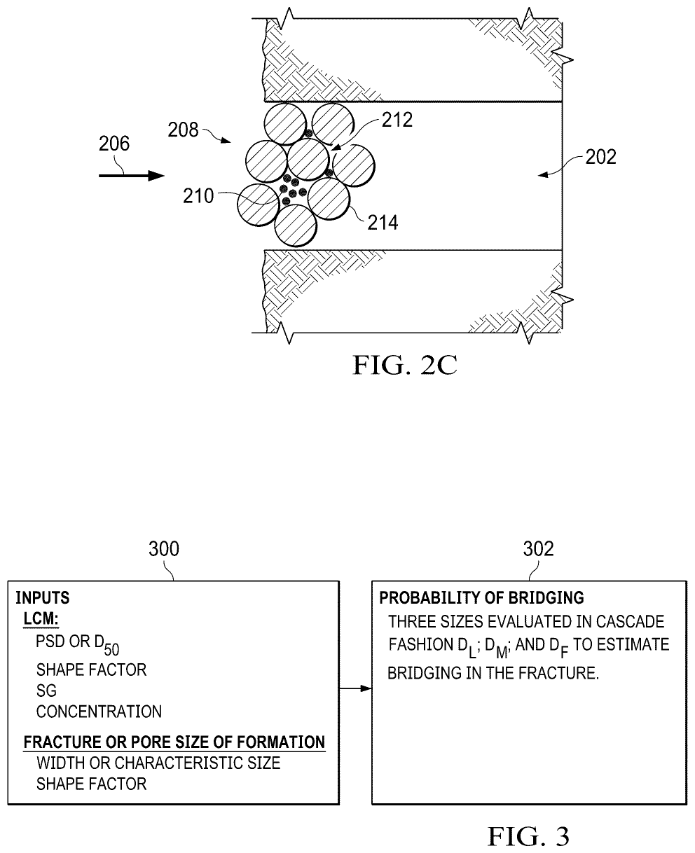

FIGS. 2A and 2B illustrate controlling circulation loss as a two-step process, in accordance with examples of the present disclosure. First, as shown on FIG. 2A, formation of an LCM bridge 200 occurs in a fracture 202. The loss direction from a wellbore into the formation 204 is indicated by the directional arrow 206. Second, as shown on FIG. 2B, filtration of fines by the LCM bridge 200 occurs to lower the permeability of resulting filter cake 208 (e.g., packing of small particles or fines in the LCM bridge). If the LCM quantity is low, the bridging may be insufficient to filter the fines. The type of the LCM might closely govern the filtration efficiency of the fines. If the amount of fines is low, the permeability of the filter cake 208 may not be sufficiently low to control losses.

FIG. 2C illustrates a close-up view of the filter cake 208, in accordance with examples of the present disclosure. For a mixture, smaller sized particles 210 can sit in the spaces 212 between larger particles 214. The loss direction from a wellbore into the fracture 202 is indicated by the directional arrow 206. The fraction of the smaller particles retained in the cake is a function of LCM PSD, LCM shape, fluid rheology, LCM concentration, the small particles' shape and PSD, any fluid loss additives.

FIG. 3 illustrates an operative sequence for a fracture bridging simulator, in accordance with examples of the present disclosure. The simulator may determine a probability of the LCM bridging in a fracture. In some examples, the simulator may employ a triple cascade technique. The simulator takes into account three particle sizes which may be used to bridge: D_{Large}; D_{Medium}; and D_{Small}. At step 300, inputs for the simulator may include LCM characteristics and fracture and pore characteristics. The LCM inputs may include PSD; shape factor, specific gravity; and concentration. The fracture and pore characteristics may include width or characteristic size and shape factor.

At step 302, the simulator may evaluate the three sizes of particles at each D₅₀ to estimate the cumulative bridging. The bridging of the fracture is done by the largest particles. The medium and small particles are then packing the bridge with more material with smaller particle size. The permeability of the filter cake is determined by the particle size (as is shown in Equation 1). The smaller the particle size, the lower the permeability. The biggest particle size will have a filter cake with high permeability and the losses may not be controlled as desired. Thus, smaller particles reduce the permeability of the filter cake.

Filtration efficiency (or probability of bridging) is related to the ratio of sizes. For example, the probability of bridging the fracture with large particles is inversely proportional to ˜(Do/Dp) where Do is the fracture opening size and Dp is the size of the LCM. When the ratio is high the probability of bridging is lower. If the ratio is lower the probability of bridging is high.

Similarly, probability of smaller particles filtered in the filter cake of larger particle is also proportional to the size ratio of the particles involved. If the small particles are too small compared to the larger particles, it will just pass through without getting filtered. The appropriate ratio here is roughly that the small particles be in the range of ˜⅓rd to 1/10th the size of the large particles to be effectively filtered. Depending on the sizes and the shapes of particles involved and the requirements on the losses, only one size, or two of the sizes (example large and the small particles) may be needed or all three sizes (large, medium and small) may be needed.

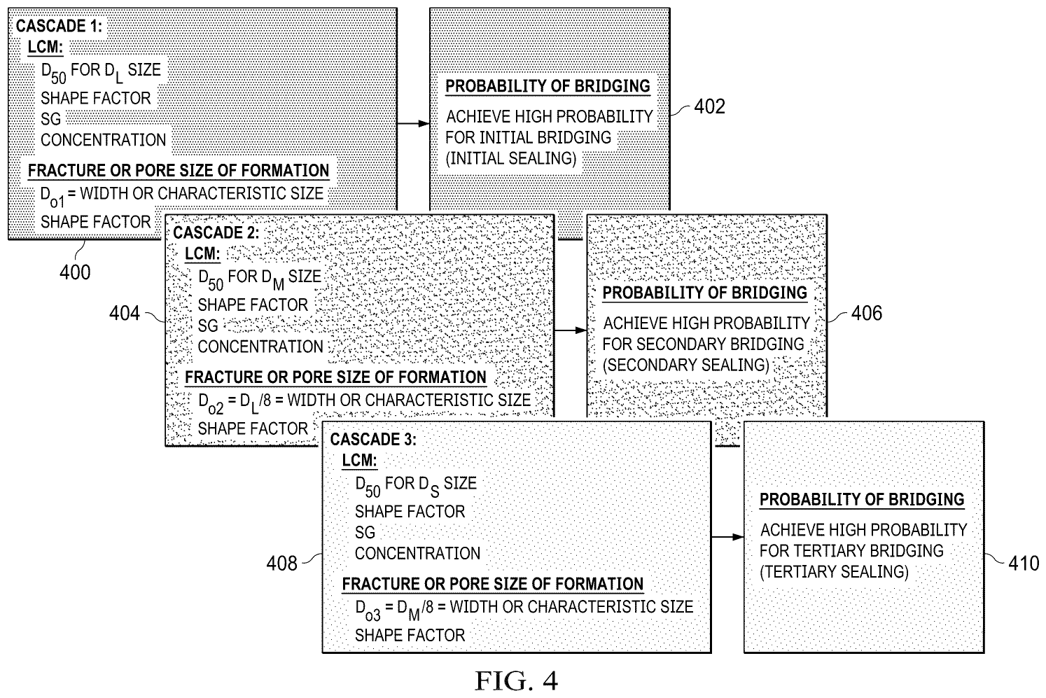

FIG. 4 illustrates triple cascade operative sequences for a fracture bridging simulator, in accordance with examples of the present disclosure. During the first cascade at box 400, the large particles are evaluated (e.g., D₅₀ for D_{L} size; shape factor; specific gravity; concentration), and the fracture or pore size of the formation is evaluated (e.g., Dₒ₁=width or characteristic size, shape factor). Dₒ₁ is the targeted fracture or matrix opening size. The probability of initial bridging with this large particle is shown in box 402. The probability might be based on the size ratios involved and one might just use a thumb rule such as the probability is high when size ratio is between ⅓ to 1/10 otherwise low. Or a mathematical formula such as probability of bridging is:

A.exp(−\alpha*d) Eq. (3)

where A and \alpha are constants for a given LCM package in a fluid with given rheology and d is (Do/Dp)\hat{ }2-1. A and \alpha might be determined using experimental data or from literature. When using mathematical model, ‘high probability’ may be either 70% or above 50%.

During the second cascade at box 404, the medium particles are evaluated (e.g., D₅₀ for D_{M} size; shape factor; specific gravity; concentration), and the fracture or pore size of the formation is evaluated (e.g., Dₒ₂=D_{L}/8=width or characteristic size, shape factor). Dₒ₂ is the interstitial space between D_{L} particles. Note that Dₒ₂ is about ⅓ or 1/10th of DL. The probability of secondary bridging (reduces leakage of first bridging with larger particles) with the medium particles is shown in box 406.

During the third cascade at box 408, the small particles are evaluated (e.g., D₅₀ for D_{S} size; shape factor; specific gravity; concentration), and the fracture or pore size of the formation is evaluated (e.g., Dₒ₃=D_{M}/8=width or characteristic size, shape factor). Dₒ₃ is the interstitial space between D_{M} particles. Note that Dₒ₃ is about ⅛ or 1/10th of DM. The probability of tertiary bridging (almost seals off leakage) with the small particles is shown in box 410.

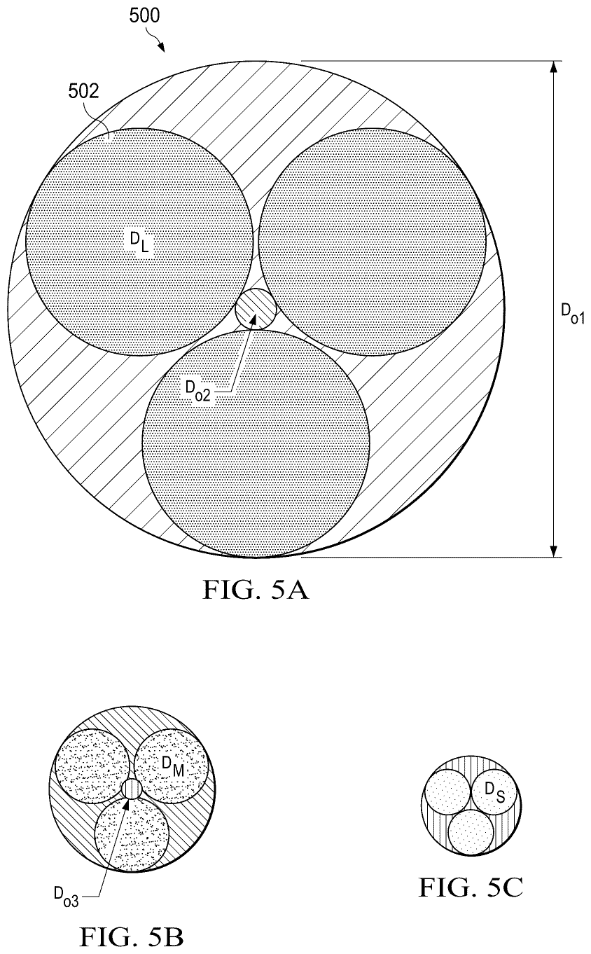

FIGS. 5A-5C illustrate different sized LCM disposed in a fracture or pore to form a bridge therein, in accordance with examples of the present disclosure. As shown on FIG. 5A, Dₒ₁ is the width of a fracture or pore 500. Large particles include DL particles disposed in the fracture or pore 500. Dₒ₂ is the interstitial space between the DL particles. As shown on FIG. 5B, medium particles include D_{M} particles disposed in Dₒ₂. Dₒ₃ is the interstitial space between D_{M} particles. FIG. 5C illustrates D_{S} includes small particles disposed in Dₒ₃. Permeability of the filter cake is based on this configuration of the particles.

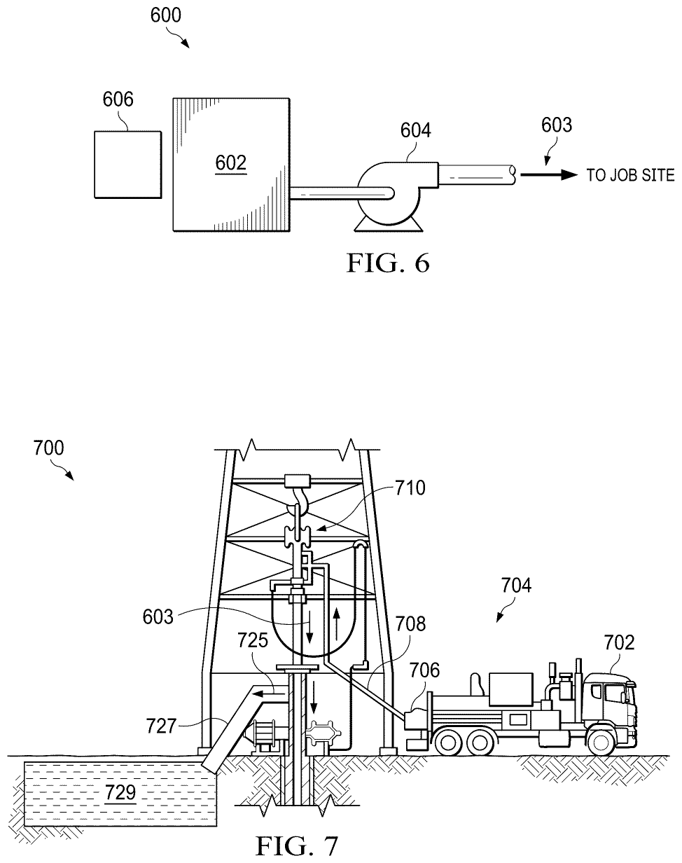

FIG. 6 illustrates a system 600 for the preparation of a designed fluid(s) and subsequent delivery of the fluid to an application site, in accordance with examples of the present disclosure. The system 600 may be used to formulate (e.g., determine and/or produce) a fluid (e.g., spacer, cement) comprising LCM to control lost circulation.

As shown, components may be mixed and/or stored in a vessel 602. The vessel 602 may be configured to contain and/or mix the components to produce or modify a designed composition 603. Non-limiting examples of the vessel 602 may include drums, barrels, tubs, bins, jet mixers, re-circulating mixers, and/or batch mixers. The designed composition 603 may then be moved (e.g., pumped via pumping equipment 604) to a location.

The system 600 may also include a computer 606 for performing the workflows as described herein and to prepare the designed composition. The computer 606 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. The computer 606 may be any processor-driven device, such as, but not limited to, a personal computer, laptop computer, smartphone, tablet, handheld computer, dedicated processing device, and/or an array of computing devices. In addition to having a processor, the computer 606 may include a server, a memory, input/output (“I/O”) interface(s), and a network interface. The memory may be any computer-readable medium, coupled to the processor, such as RAM, ROM, and/or a removable storage device for storing data and a database management system (“DBMS”) to facilitate management of data stored in memory and/or stored in separate databases.

The computer 606 may also include display devices such as a monitor featuring an operating system, media browser, and the ability to run one or more software applications. Additionally, the computer 606 may include non-transitory computer-readable media. Non-transitory computer-readable media may include any instrumentality or aggregation of instrumentalities that may retain data and/or instructions for a period of time.

FIG. 7 illustrates a system 700 that may be used in the placement of a designed composition, in accordance with examples of the present disclosure. It should be noted that while FIG. 7 generally depicts a land-based operation, those skilled in the art will readily recognize that the principles described herein are equally applicable to subsea operations that employ floating or sea-based platforms and rigs, without departing from the scope of the disclosure.

The system 700 may include a cementing unit 702, which may include one or more cement trucks, for example. The cementing unit 702 may include mixing equipment 704 and pumping equipment 706. The cementing unit 702 may pump the designed composition 603, through a feed pipe 708 and to a cementing head 710 which conveys the composition 603 into a downhole environment.

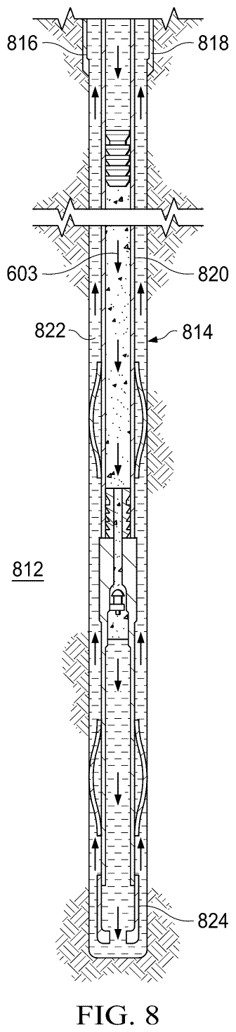

With additional reference to FIG. 8, the composition 603 may be placed in a subterranean formation 812. A wellbore 814 may be drilled into the subterranean formation 812. While the wellbore 814 is shown generally extending vertically into the subterranean formation 812, the principles described herein are also applicable to wellbores that extend at an angle through subterranean formation 812, such as horizontal and slanted wellbores.

A first section 816 of casing may be inserted into the wellbore 814. The section 816 may be cemented in place by a cement sheath 818. A second section 820 of casing may also be disposed in the wellbore 814. A wellbore annulus 822 formed between the second section 820 and walls of the wellbore 814 and/or the first section 816.

The composition 603 may be pumped down the interior of the second section 820 of casing. The composition 603 may be allowed to flow down the interior of the casing through the casing shoe 824 at the bottom of the second section 820 and up around the second section 820 of casing into the wellbore annulus 822. As it is introduced, the composition 603 may displace other fluids 825, such as drilling fluids and/or spacer fluids that may be present in the interior of the casing and/or the wellbore annulus 822. At least a portion of the displaced fluids 825 may exit the wellbore annulus 822 via a flow line 827 and be deposited, for example, in one or more retention pits 829.

Other techniques may also be utilized for introduction of the composition 603. For example, reverse circulation techniques may be used that include introducing the composition 603 into the subterranean formation 812 via the wellbore annulus 822 instead of through the casing (e.g., section 820). Table 1 illustrates information of various slurries with different amounts of LCM.

TABLE 1
Slurries and LCM.

| | | | Spacer | | | | | | |
|---|---|---|---|---|---|---|---|---|---|
| | | Barite | to water | | | PPA | PPA | | |
| | LCM | mass | ratio | Density | | 30 S | 30 M | SG | SG |
| Slurry # | (lb/bbl) | fraction | (wt/w) | (ppg) | Mixability | [ml] | [ml] | 30 S | 30 M |
| 1 | 6 | 0.85 | 0.23 | 15.07 | 5 | 20 | 11 | 1.81 | 1.41 |
| 2 | 6 | 0.60 | 0.50 | 13.53 | 0 | — | — | — | — |
| 3 | 28 | 0.60 | 0.50 | 13.53 | 0 | — | — | — | — |
| 4 | 17 | 0.60 | 0.03 | 13.24 | 5 | NA | NA | NA | NA |
| 5 | 17 | 0.97 | 0.03 | 8.55 | 5 | NA | NA | NA | NA |
| 6 | 6 | 0.39 | 0.03 | 8.45 | 5 | NA | NA | NA | NA |
| 7 | 6 | 0 | 0.50 | 10.31 | 1 | 34 | 8 | 1.24 | 1.24 |
| 8 | 28 | 0 | 0.26 | 9.46 | 5 | 8 | 2 | 1.12 | 1.11 |
| 9 | 28 | 0.97 | 0.03 | 13.24 | 5 | 24 | 35 | 1.56 | 1.38 |
| 10 | 17.29 | 0 | 0.5 | 10.31 | 1 | 28 | 7 | 1.23 | 1.21 |
| 11 | 28 | 0.39 | 0.26 | 8.55 | 5 | NA | NA | NA | NA |
| 12 | 17 | 0.47 | 0.03 | 10.68 | 5 | 6 | 3 | 1.24 | 1.23 |
| 2N | 6 | 0.604 | 0.26 | 12.3 | 1 | 28 | 4 | 1.47 | 1.34 |
| 3N | 28 | 0.604 | 0.35 | 12.3 | 1 | 0 | 2 | | 1.33 |
| 4N | 17 | 0.973 | 0.05 | 16.38 | 5 | 38 | 8 | 1.97 | 1.19 |
| 5N | 17 | 0.389 | 0.1 | 9 | 5 | 25 | 5 | 1.1 | 1.06 |
| 6N | 6 | 0 | 0.15 | 9 | 5 | 27 | 6 | 1.081 | 1.01 |
| 11N | 28 | 0.3892 | 0.1 | 9.16 | 5 | 93 | 10 | 1.1 | 1.03 |

Slurries 4-6 and 11 do not control losses due to thin rheology and/or small amount of fines in the design. Slurries 2 and 3 are non-mixable designs. When a PPA experiment is conducted, the resulting filtrate is collected. As per API the initial ‘spurt’ loss is captured in first 30 sec and is termed as 30 S loss. The filtrate collected after 30 sec and up to 30 minutes is labeled as 30 M (or 30 min) loss. The SG of both the filtrates are collected (30 sec and 30 min) and labeled as SG 30 S and SG 30 M.

The fines (or medium and small particles) are added to lower the permeability. For these experiments, the amount of fines is equal to total amount of spacer in the formulation. For experiment 4-6 the spacer to water ratio is 0.03 (by weight) and in 11 the spacer to water ratio is 0.26 which is relatively high but the rheology was probably thin as indicated by the low density (8.55).

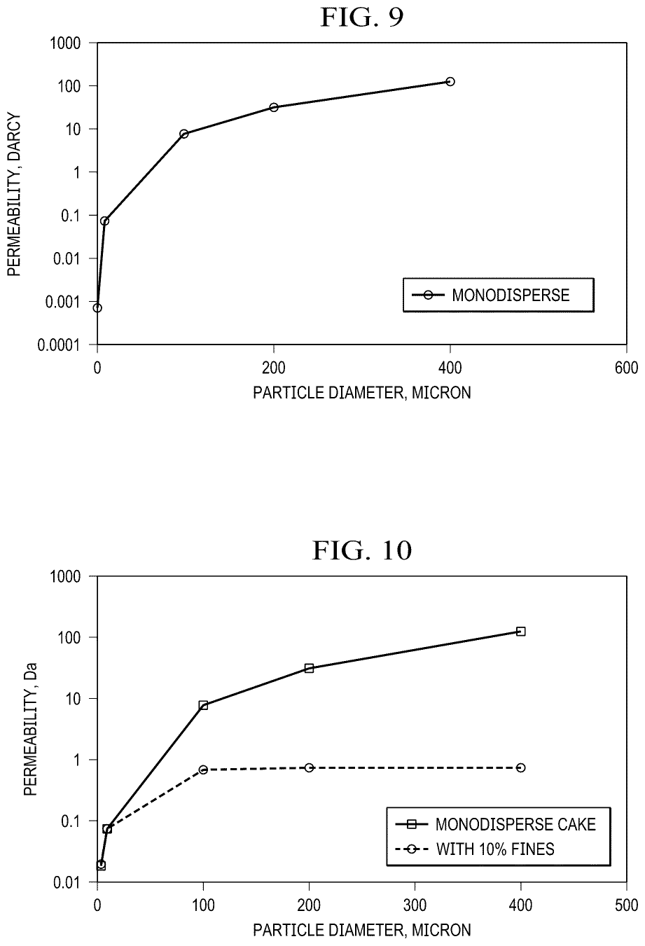

FIG. 9 illustrates that the permeability of the filter cake increases significantly with the particle size, in accordance with examples of the present disclosure. As the primary LCM particle size increases, it is desired to balance them with the smaller particles.

FIG. 10 illustrates that the permeability of the filter cake is severely limited with the presence of finer particles, in accordance with examples of the present disclosure. The graph assumes 10% of fines of 10-micron particles. The efficacy of the presence of smaller particles in reducing the permeability of filter cake is shown.

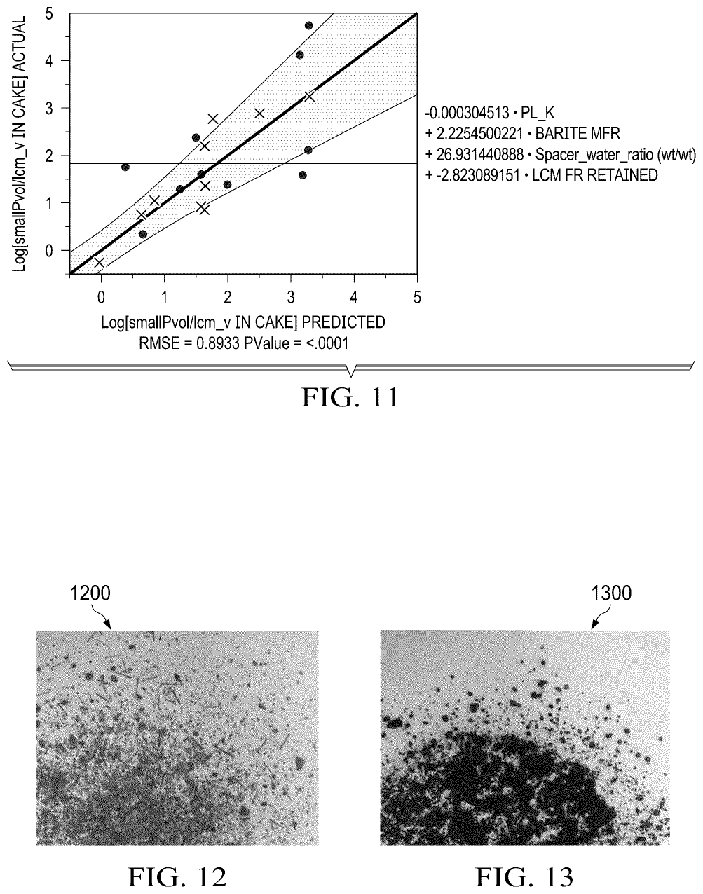

FIG. 11 illustrates a model for fines in the filter cake, in accordance with examples of the present disclosure. FIG. 11 shows how the model of filter cake build up may be built using experimental data from PPA. It also shows various factors which govern the filter cake build up—specifically showing how the much the small particles might accumulate in the filter cake. (Small_particle/Large_particles) in the filter cake=f(rheology of the fluid, amount of small particles, amount of large particles, PSD and aspect ratio of both large and small particles)

One example form is:

(Small_particle/Large_particles)=M. exp(a.(power law consistency factor)+b.(mass fraction of small particles)+c. (mass fraction of medium sized particles)+d.(probability of bridging of large particles at the fracture opening)) Eq. (4)

where M, a,b,c and d are constants which may be determined using PPA experimental data.

FIG. 12 illustrates an LCM package 1200, in accordance with examples of the present disclosure. FIG. 12 has different shaped particles and consists of high aspect ratio particles (essentially rods and discs) mixed with rounded particles.

FIG. 13 illustrates an LCM package 1300, in accordance with examples of the present disclosure. FIG. 13 shows an LCM package which is essentially rounded particles.

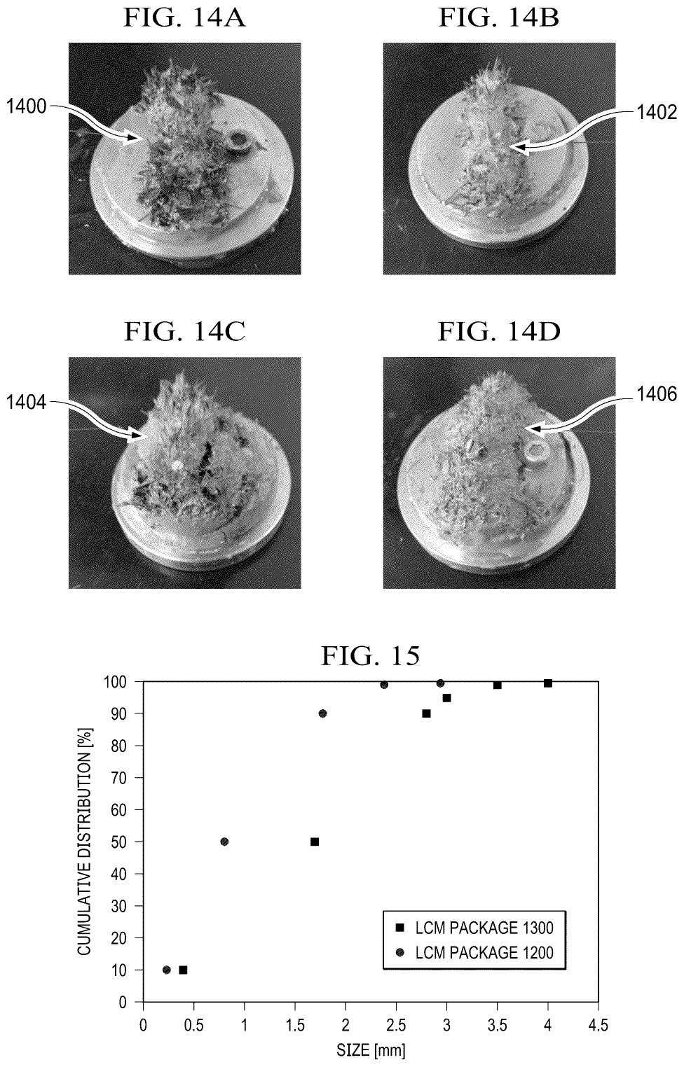

FIGS. 14A-14D illustrate LCM bridges with different LCM weights in fluid in a 1250 micron slot/fracture, in accordance with examples of the present disclosure. FIG. 14A illustrates a 12 lb/bbl LCM bridge 1400 including the filter cake. FIG. 14B illustrates a 17 lb/bbl LCM bridge 1402 including the filter cake. FIG. 14C illustrates a 22 lb/bbl LCM bridge 1404 including the filter cake. FIG. 14D illustrates a 28 lb/bbl LCM bridge 1406 including the filter cake.

FIG. 15 illustrates cumulative distribution of the LCM packages 1200 and 1300 according to size, in accordance with examples of the present disclosure. FIG. 15 shows that the LCM package used consists of large sized particles and they have significant overlap in the sizes used.

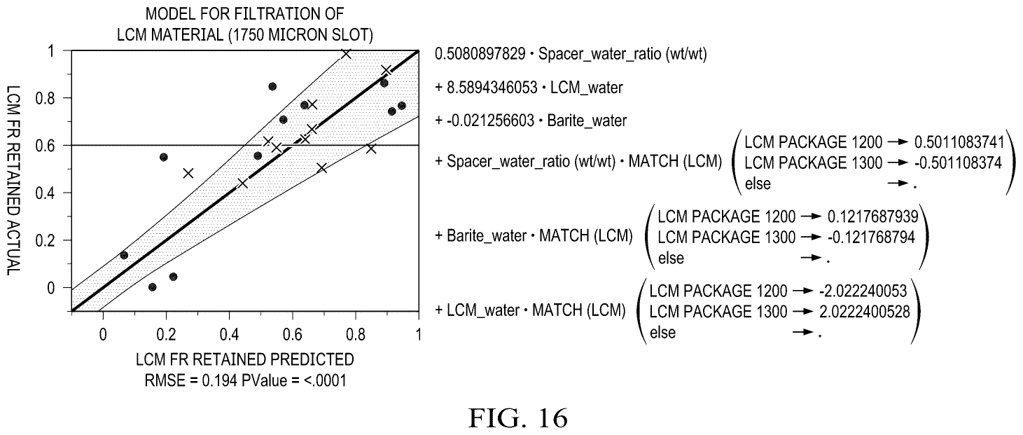

FIG. 16 illustrates a model for filtration of LCM material, in accordance with examples of the present disclosure. A fraction of LCM retained is a function of the formulation. For example, the higher the LCM amount, the higher the fraction retained. The LCM package 1300 is more sensitive to the LCM concentration compared to the LCM package 1200. The LCM package 1300 performs well at a higher concentration. The LCM package 1200 is sensitive to rheology (spacer amount); performance is enhanced for thicker fluids.

As noted above, the probability of bridging is A. exp(alpha. d) where A and \alpha are constants. In general, though A and \alpha depend on the LCM PSD, LCM shape, LCM concentration and rheology of the fluid. The model on FIG. 16 depicts one embodiment of such models and gives the fraction of LCM retained on the fracture opening (of fixed size) as a function of LCM type, LCM concentration, and concentration of other particles. Note that presence of other particles in the fluid (especially small particles) also changes the rheology of the fluid.

Cement slurries described herein may generally include a hydraulic cement and water. A variety of hydraulic cements may be utilized in accordance with the present disclosure, including, but not limited to, those comprising calcium, aluminum, silicon, oxygen, iron, and/or sulfur, which set and harden by reaction with water. Suitable hydraulic cements may include, but are not limited to, Portland cements, pozzolana cements, gypsum cements, high alumina content cements, silica cements, and any combination thereof. In certain examples, the hydraulic cement may include a Portland cement. In some examples, the Portland cements may include Portland cements that are classified as Classes A, C, H, and G cements according to American Petroleum Institute, API Specification for Materials and Testing for Well Cements, API Specification 10, Fifth Ed., Jul. 1, 1990. In addition, hydraulic cements may include cements classified by American Society for Testing and Materials (ASTM) in C150 (Standard Specification for Portland Cement), C595 (Standard Specification for Blended Hydraulic Cement) or C1157 (Performance Specification for Hydraulic Cements) such as those cements classified as ASTM Type I, II, or III. The hydraulic cement may be included in the cement slurry in any amount suitable for a particular composition. In some examples, the hydraulic cement may include resin (e.g., up to 25% resin by weight of the hydraulic cement). Without limitation, the hydraulic cement may be included in the cement slurries in an amount in the range of from about 10% to about 80% by weight of dry blend in the cement slurry. For example, the hydraulic cement may be present in an amount ranging between any of and/or including any of about 10%, about 15%, about 20%, about 25%, about 30%, about 35%, about 40%, about 45%, about 50%, about 55%, about 60%, about 65%, about 70%, about 75%, or about 80% by weight of the cement slurries.

The water may be from any source provided that it does not contain an excess of compounds that may undesirably affect other components in the cement slurries. For example, a cement slurry may include fresh water or saltwater. Saltwater generally may include one or more dissolved salts therein and may be saturated or unsaturated as desired for a particular application. Seawater or brines may be suitable for use in some examples. Further, the water may be present in an amount sufficient to form a pumpable slurry. In certain examples, the water may be present in the cement slurry in an amount in the range of from about 33% to about 200% by weight of the cementitious materials. For example, the water cement may be present in an amount ranging between any of and/or including any of about 33%, about 50%, about 75%, about 100%, about 125%, about 150%, about 175%, or about 200% by weight of the cementitious materials. The cementitious materials referenced may include all components which contribute to the compressive strength of the cement slurry such as the hydraulic cement and supplementary cementitious materials, for example.

As mentioned above, the cement slurry may include supplementary cementitious materials. The supplementary cementitious material may be any material that contributes to the desired properties of the cement slurry. Some supplementary cementitious materials may include, without limitation, fly ash, blast furnace slag, silica fume, pozzolans, kiln dust, and clays, for example.

The cement slurry may include kiln dust as a supplementary cementitious material. “Kiln dust,” as that term is used herein, refers to a solid material generated as a by-product of the heating of certain materials in kilns. The term “kiln dust” as used herein is intended to include kiln dust made as described herein and equivalent forms of kiln dust. Depending on its source, kiln dust may exhibit cementitious properties in that it can set and harden in the presence of water. Examples of suitable kiln dusts include cement kiln dust, lime kiln dust, and combinations thereof. Cement kiln dust may be generated as a by-product of cement production that is removed from the gas stream and collected, for example, in a dust collector. Usually, large quantities of cement kiln dust are collected in the production of cement that are commonly disposed of as waste. The chemical analysis of the cement kiln dust from various cement manufactures varies depending on a number of factors, including the particular kiln feed, the efficiencies of the cement production operation, and the associated dust collection systems. Cement kiln dust generally may include a variety of oxides, such as SiO₂, Al₂O₃, Fe₂O₃, CaO, MgO, SO₃, Na₂O, and K₂O. The chemical analysis of lime kiln dust from various lime manufacturers varies depending on several factors, including the particular limestone or dolomitic limestone feed, the type of kiln, the mode of operation of the kiln, the efficiencies of the lime production operation, and the associated dust collection systems. Lime kiln dust generally may include varying amounts of free lime and free magnesium, limestone, and/or dolomitic limestone and a variety of oxides, such as SiO₂, Al₂O₃, Fe₂O₃, CaO, MgO, SO₃, Na₂O, and K₂O, and other components, such as chlorides. A cement kiln dust may be added to the cement slurry prior to, concurrently with, or after activation. Cement kiln dust may include a partially calcined kiln feed which is removed from the gas stream and collected in a dust collector during the manufacture of cement. The chemical analysis of CKD from various cement manufactures varies depending on a number of factors, including the particular kiln feed, the efficiencies of the cement production operation, and the associated dust collection systems. CKD generally may comprise a variety of oxides, such as SiO₂, Al₂O₃, Fe₂O₃, CaO, MgO, SO₃, Na₂O, and K₂O. The CKD and/or lime kiln dust may be included in examples of the cement slurry in an amount suitable for a particular application.

In some examples, the cement slurry may further include one or more of slag, natural glass, shale, amorphous silica, or metakaolin as a supplementary cementitious material. Slag is generally a granulated, blast furnace by-product from the production of cast iron including the oxidized impurities found in iron ore. The cement may further include shale. A variety of shales may be suitable, including those including silicon, aluminum, calcium, and/or magnesium. Examples of suitable shales include vitrified shale and/or calcined shale. In some examples, the cement slurry may further include amorphous silica as a supplementary cementitious material. Amorphous silica is a powder that may be included in embodiments to increase cement compressive strength. Amorphous silica is generally a byproduct of a ferrosilicon production process, wherein the amorphous silica may be formed by oxidation and condensation of gaseous silicon suboxide, SiO, which is formed as an intermediate during the process

In some examples, the cement slurry may further include a variety of fly ashes as a supplementary cementitious material which may include fly ash classified as Class C, Class F, or Class N fly ash according to American Petroleum Institute, API Specification for Materials and Testing for Well Cements, API Specification 10, Fifth Ed., Jul. 1, 1990. In some examples, the cement slurry may further include zeolites as supplementary cementitious materials. Zeolites are generally porous alumino-silicate minerals that may be either natural or synthetic. Synthetic zeolites are based on the same type of structural cell as natural zeolites and may comprise aluminosilicate hydrates. As used herein, the term “zeolite” refers to all natural and synthetic forms of zeolite.

Where used, one or more of the aforementioned supplementary cementitious materials may be present in the cement slurry. For example, without limitation, one or more supplementary cementitious materials may be present in an amount of about 0.1% to about 80% by weight of the cement slurry. For example, the supplementary cementitious materials may be present in an amount ranging between any of and/or including any of about 0.1%, about 10%, about 20%, about 30%, about 40%, about 50%, about 60%, about 70%, or about 80% by weight of the cement.

In some examples, the cement slurry may further include hydrated lime. As used herein, the term “hydrated lime” will be understood to mean calcium hydroxide. In some embodiments, the hydrated lime may be provided as quicklime (calcium oxide) which hydrates when mixed with water to form the hydrated lime. The hydrated lime may be included in examples of the cement slurry, for example, to form a hydraulic composition with the supplementary cementitious components. For example, the hydrated lime may be included in a supplementary cementitious material-to-hydrated-lime weight ratio of about 10:1 to about 1:1 or 3:1 to about 5:1. Where present, the hydrated lime may be included in the set cement slurry in an amount in the range of from about 10% to about 100% by weight of the cement slurry, for example. In some examples, the hydrated lime may be present in an amount ranging between any of and/or including any of about 10%, about 20%, about 40%, about 60%, about 80%, or about 100% by weight of the cement slurry. In some examples, the cementitious components present in the cement slurry may consist essentially of one or more supplementary cementitious materials and the hydrated lime. For example, the cementitious components may primarily comprise the supplementary cementitious materials and the hydrated lime without any additional components (e.g., Portland cement, fly ash, slag cement) that hydraulically set in the presence of water.

Lime may be present in the cement slurry in several; forms, including as calcium oxide and or calcium hydroxide or as a reaction product such as when Portland cement reacts with water. Alternatively, lime may be included in the cement slurry by amount of silica in the cement slurry. A cement slurry may be designed to have a target lime to silica weight ratio. The target lime to silica ratio may be a molar ratio, molal ratio, or any other equivalent way of expressing a relative amount of silica to lime. Any suitable target time to silica weight ratio may be selected including from about 10/90 lime to silica by weight to about 40/60 lime to silica by weight. Alternatively, about 10/90 lime to silica by weight to about 20/80 lime to silica by weight, about 20/80 lime to silica by weight to about 30/70 lime to silica by weight, or about 30/70 lime to silica by weight to about 40/63 lime to silica by weight.

Other additives suitable for use in subterranean cementing operations also may be included in embodiments of the cement slurry. Examples of such additives include, but are not limited to: weighting agents, lightweight additives, gas-generating additives, mechanical-property-enhancing additives, lost-circulation materials, filtration-control additives, fluid-loss-control additives, defoaming agents, foaming agents, thixotropic additives, and combinations thereof. In embodiments, one or more of these additives may be added to the cement slurry after storing but prior to the placement of a cement slurry into a subterranean formation. In some examples, the cement slurry may further include a dispersant. Examples of suitable dispersants include, without limitation, sulfonated-formaldehyde-based dispersants (e.g., sulfonated acetone formaldehyde condensate) or polycarboxylated ether dispersants. In some examples, the dispersant may be included in the cement slurry in an amount in the range of from about 0.01% to about 5% by weight of the cementitious materials. In specific examples, the dispersant may be present in an amount ranging between any of and/or including any of about 0.01%, about 0.1%, about 0.5%, about 1%, about 2%, about 3%, about 4%, or about 5% by weight of the cementitious materials.

In some examples, the cement slurry may further include a set retarder. A broad variety of set retarders may be suitable for use in the cement slurries. For example, the set retarder may comprise phosphonic acids, such as ethylenediamine tetra(methylene phosphonic acid), diethylenetriamine penta(methylene phosphonic acid), etc.; lignosulfonates, such as sodium lignosulfonate, calcium lignosulfonate, etc.; salts such as stannous sulfate, lead acetate, monobasic calcium phosphate, organic acids, such as citric acid, tartaric acid, etc.; cellulose derivatives such as hydroxyl ethyl cellulose (HEC) and carboxymethyl hydroxyethyl cellulose (CMHEC); synthetic co- or ter-polymers comprising sulfonate and carboxylic acid groups such as sulfonate-functionalized acrylamide-acrylic acid co-polymers; borate compounds such as alkali borates, sodium metaborate, sodium tetraborate, potassium pentaborate; derivatives thereof, or mixtures thereof. Examples of suitable set retarders include, among others, phosphonic acid derivatives. Generally, the set retarder may be present in the cement slurry in an amount sufficient to delay the setting for a desired time. In some examples, the set retarder may be present in the cement slurry in an amount in the range of from about 0.01% to about 10% by weight of the cementitious materials. In specific examples, the set retarder may be present in an amount ranging between any of and/or including any of about 0.01%, about 0.1%, about 1%, about 2%, about 4%, about 6%, about 8%, or about 10% by weight of the cementitious materials.

In some examples, the cement slurry may further include an accelerator. A broad variety of accelerators may be suitable for use in the cement slurries. For example, the accelerator may include, but are not limited to, aluminum sulfate, alums, calcium chloride, calcium nitrate, calcium nitrite, calcium formate, calcium sulphoaluminate, calcium sulfate, gypsum-hemihydrate, sodium aluminate, sodium carbonate, sodium chloride, sodium silicate, sodium sulfate, ferric chloride, or a combination thereof. In some examples, the accelerators may be present in the cement slurry in an amount in the range of from about 0.01% to about 10% by weight of the cementitious materials. In specific examples, the accelerators may be present in an amount ranging between any of and/or including any of about 0.01%, about 0.1%, about 1%, about 2%, about 4%, about 6%, about 8%, or about 10% by weight of the cementitious materials.

Cement slurries generally should have a density suitable for a particular application. By way of example, the cement slurry may have a density in the range of from about 8 pounds per gallon (“ppg”) (959 kg/m³) to about 20 ppg (2397 kg/m³), or about 8 ppg to about 12 ppg (1437. kg/m³), or about 12 ppg to about 16 ppg (1917.22 kg/m³), or about 16 ppg to about 20 ppg, or any ranges therebetween. Examples of the cement slurry may be foamed or unfoamed or may comprise other means to reduce their densities, such as hollow microspheres, low-density elastic beads, or other density-reducing additives known in the art.

The cement slurries disclosed herein may be used in a variety of subterranean applications, including primary and remedial cementing. The cement slurries may be introduced into a subterranean formation and allowed to set. In primary cementing applications, for example, the cement slurries may be introduced into the annular space between a conduit located in a wellbore and the walls of the wellbore (and/or a larger conduit in the wellbore), wherein the wellbore penetrates the subterranean formation. The cement slurry may be allowed to set in the annular space to form an annular sheath of hardened cement. The cement slurry may form a barrier that prevents the migration of fluids in the wellbore. The cement slurry may also, for example, support the conduit in the wellbore. In remedial cementing applications, the cement slurry may be used, for example, in squeeze cementing operations or in the placement of cement plugs. By way of example, the cement slurry may be placed in a wellbore to plug an opening (e.g., a void or crack) in the formation, in a gravel pack, in the conduit, in the cement sheath, and/or between the cement sheath and the conduit (e.g., a micro annulus).

Accordingly, the methods of the present disclosure determine suitable LCM based on the permeability of the resulting filter cake. The methods may include any of the various features disclosed herein, including one or more of the following statements.

Statement 1. A method comprises determining if a lost circulation material (LCM) has the potential to bridge a fracture, the fracture extending from a wellbore; determining a permeability of filter cake formed due to the LCM, wherein the permeability is determined if the LCM has the potential to bridge the fracture; and formulating a composition that includes the LCM, to control losses from the wellbore.

Statement 2. The method of the statement 1, further comprising modifying the LCM.

Statement 3. The method of any of the preceding statements, wherein determining the potential is based in part on large particles of the LCM.

Statement 4. The method of any of the preceding statements, wherein determining the potential is also based in part on medium particles of the LCM that exist in spaces between the large particles.

Statement 5. The method of any of the preceding statements, wherein determining the potential is also based in part on small particles of the LCM that exist in spaces between the medium particles.

Statement 6. The method of any of the preceding statements, further comprising determining the potential of initial sealing with the large particles.

Statement 7. The method of any of the preceding statements, further comprising determining the potential of sealing with the large particles and the medium particles.

Statement 8. The method of any of the preceding statements, further comprising determining the potential of tertiary sealing with the medium particles and the small particles.

Statement 9. The method of any of the preceding statements, wherein determining the probability is based on size, shape, specific gravity, and concentration of the LCM, and characteristics of the fracture.

Statement 10. The method of any of the preceding statements, further comprising pumping the LCM into the wellbore.

Statement 11. A method comprising: characterizing a fracture extending from a wellbore; characterizing a lost circulation material (LCM); determining a probability that the LCM bridges the fracture; determining a permeability of filter cake formed on the LCM; and formulating a fluid that includes the LCM, to control losses from the wellbore.

Statement 12. The method of any of the statement 11, wherein determining the probability is based in part on large particles of the LCM.

Statement 13. The method of any of the statements 11-12, wherein determining the probability is also based in part on medium particles of the LCM that exist in spaces between the large particles.

Statement 14. The method of any of the statements 11-13, wherein determining the probability is also based in part on small particles of the LCM that exist in spaces between the medium particles.

Statement 15. A method comprising: determining if a lost circulation material (LCM) has the potential to bridge a fracture extending from a wellbore; modifying the LCM if the LCM does not have the potential; determining a permeability of filter cake formed due to the LCM in the fracture, wherein the permeability is determined if the LCM has the potential to bridge the fracture; and formulating a composition that includes the LCM, to control losses from the wellbore.

Statement 16. The method of any of the statement 15, wherein determining the potential is based in part on large particles of the LCM.

Statement 17. The method of any of the statements 15-16, wherein determining the potential is also based in part on medium particles of the LCM that exist in spaces between the large particles.

Statement 18. The method of any of the statements 15-17, wherein determining the potential is also based in part on small particles of the LCM that exist in spaces between the medium particles.

Statement 19. The method of any of the statements 15-18, wherein determining the potential is based on size, shape, specific gravity, and concentration of the LCM, and characteristics of the fracture.

Statement 20. The method of any of the statements 15-19, further comprising pumping the composition into the wellbore.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, as the present embodiments may be modified and practiced in different but equivalent manners. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

What is claimed is:

1. A method comprising:
determining if a lost circulation material (LCM) has the potential to bridge a fracture, the fracture extending from a wellbore;
determining a permeability of filter cake formed due to the LCM, wherein the permeability is determined if the LCM has the potential to bridge the fracture; and
formulating a composition that includes the LCM, to control losses from the wellbore.

2. The method of claim 1, further comprising modifying the LCM.

3. The method of claim 1, wherein determining the potential is based in part on large particles of the LCM.

4. The method of claim 3, wherein determining the potential is also based in part on medium particles of the LCM that exist in spaces between the large particles.

5. The method of claim 4, wherein determining the potential is also based in part on small particles of the LCM that exist in spaces between the medium particles.

6. The method of claim 3, further comprising determining the potential of initial sealing with the large particles.

7. The method of claim 4, further comprising determining a potential of sealing with the large particles and the medium particles.

8. The method of claim 5, further comprising determining a potential of tertiary sealing with the medium particles and the small particles.

9. The method of claim 1, wherein determining the potential is based on size, shape, specific gravity, and concentration of the LCM, and characteristics of the fracture.

10. The method of claim 1, further comprising pumping the LCM into the wellbore.

11. A method comprising:
characterizing a fracture extending from a wellbore;
characterizing a lost circulation material (LCM);
determining a probability that the LCM bridges the fracture;
determining a permeability of filter cake formed on the LCM; and
formulating a fluid that includes the LCM, to control losses from the wellbore.

12. The method of claim 11 wherein determining the probability is based in part on large particles of the LCM.

13. The method of claim 12, wherein determining the probability is also based in part on medium particles of the LCM that exist in spaces between the large particles.

14. The method of claim 13, wherein determining the probability is also based in part on small particles of the LCM that exist in spaces between the medium particles.

15. A method comprising:
determining if a lost circulation material (LCM) has the potential to bridge a fracture extending from a wellbore;
modifying the LCM if the LCM does not have the potential;
determining a permeability of filter cake formed due to the LCM in the fracture, wherein the permeability is determined if the LCM has the potential to bridge the fracture; and
formulating a composition that includes the LCM, to control losses from the wellbore.

16. The method of claim 15, wherein determining the potential is based in part on large particles of the LCM.

17. The method of claim 16, wherein determining the potential is also based in part on medium particles of the LCM that exist in spaces between the large particles.

18. The method of claim 17, wherein determining the potential is also based in part on small particles of the LCM that exist in spaces between the medium particles.

19. The method of claim 15, wherein determining the potential is based on size, shape, specific gravity, and concentration of the LCM, and characteristics of the fracture.

20. The method of claim 15, further comprising pumping the composition into the wellbore.
